(19) United States
(12) Patent Application Publication
(10) Pub. No.: US 2023/0224811 A1
(43) Pub. Date: Jul. 13, 2023

(54) TRACKING REFERENCE SIGNAL AVAILABILITY INDICATION VALIDITY DURATION

(71) Applicant: QUALCOMM Incorporated, San Diego, CA (US)

(72) Inventors: Huilin XU, Temecula, CA (US); Yuchul KIM, San Diego, CA (US)

(21) Appl. No.: 17/647,444

(22) Filed: Jan. 7, 2022

(51) Int. Cl. H04W 52/02; H04L 5/00; H04W 56/00; H04W 68/02

(52) U.S. Cl. CPC H04W 52/0229; H04L 5/0051; H04W 56/0035; H04W 68/02

(57) ABSTRACT

Some techniques described herein provide selective application of a validity duration, cessation of transmission of a tracking reference signal (TRS), indication of an availability indication via a paging PDCCH when no user equipment (UE) is paged, and application of an availability indication based at least in part on an offset such that the availability indication is applied only after the availability indication is received. By selectively applying the validity duration, the network can avoid being bound to a validity duration when no TRS is to be transmitted. The network can cease transmission of a TRS during a validity duration, or may reduce the occurrence of repeated validity durations, thereby reducing overhead. By indicating the availability indication when no UE is paged, the network can update availability indication even when no UE is paged, which reduces overhead relative to only updating availability indication when a UE is paged.

### FIELD OF THE DISCLOSURE

Aspects of the present disclosure generally relate to wireless communication and to techniques and apparatuses associated with a tracking reference signal (TRS) availability indication validity duration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

A network may use a paging mechanism to reduce power consumption by user equipments (UEs). A paging physical downlink control channel (PDCCH) may notify a UE that a data communication to the UE is expected, which enables the UE to enter a low power state such as a deep sleep prior to receiving a paging PDCCH. Further power savings can be achieved by the use of a paging early indication (PEI). A PEI indicates to a UE or a group of UEs whether to process paging PDCCHs in one or more paging occasions, which enables the UE or group of UEs to selectively process paging PDCCHs, thereby saving power.

A UE may perform tracking loops, such as a frequency tracking loop and a time tracking loop, to maintain synchronization with the network. A UE in idle or inactive states (e.g., radio resource control (RRC) idle or inactive states) may experience more severe frequency and time tracking drift than a UE in an active state due to the longer time between communications of a UE in an idle or inactive mode. A tracking reference signal (TRS) enables power savings for a UE in an idle or inactive mode by allowing the UE to quickly update tracking loops, which provides a longer total deep sleep time for the UE. An availability indication (availability indication) may indicate to a UE that a TRS is available or unavailable for the length of a configured validity duration. The availability indication may be provided via a PEI or a paging PDCCH. Within the validity duration, the availability indication received by a UE remains valid. That is, the UE can assume that the availability indication does not change within the validity duration. Once the validity duration expires, the UE may not assume that a TRS is transmitted. The validity duration provides for a TRS to be automatically deactivated so that TRSs do not need to be continually transmitted if no PEIs or paging PDCCHs are transmitted to a UE.

Some ambiguities and inefficiencies may arise in the course of signaling availability indications and applying the corresponding validity durations. For example, a validity duration may start based at least in part on receiving an availability indication. Within the validity duration, it is not clear whether the UE should expect to receive inconsistent (e.g., updated or different) availability indication. As another example, if, before the validity duration expires, the UE receives another availability indication (e.g., any UE is paged), the validity duration is restarted, and it is unclear whether the UE should expect another availability indication with inconsistent availability indication within the validity duration. As still another example, the network may not inform UEs of whether an availability indication is the first transmission in the validity duration or not. For example, if a UE camps on a cell, the UE cannot tell whether the availability indication that the UE has received is the first one in the validity duration or not, which creates ambiguity with regard to application of the validity duration. Also, there is no dedicated signaling for the availability indication (that is, when any UE is paged, the availability indication must be provided), which can lead to frequent resetting of the validity duration and an inability of the network to modify or cease TRS transmission. For example, if UEs are paged frequently (more than once before the validity duration expires), there is no way for the network to disable the transmission of the TRS by indicating the unavailability of the TRS, which may cause increased overhead and unnecessary transmission of TRSs.

Some techniques and apparatuses described herein provide techniques for selective application of a validity duration, cessation of transmission of a TRS, indication of an availability indication via a paging PDCCH when no UE is paged, and application of an availability indication based at least in part on an offset such that the availability indication is applied only after the availability indication is received. By selectively applying the validity duration, the network can avoid being bound to a validity duration when no TRS is to be transmitted, which improves flexibility of TRS signaling relative to requiring a validity duration to be applied for any PEI or paging PDCCH. As mentioned above, some techniques and apparatuses described herein provide cessation of transmission of a TRS, such as by indicating whether an availability indication is the first availability indication in a given validity duration, by guaranteeing that all availability indications in a validity duration carry the same availability indication, by applying a time offset to allow updated availability indication, or by allowing availability indication to be updated within a validity duration. Thus, the network can cease transmission of a TRS during a validity duration, or may reduce the occurrence of repeated validity durations, thereby reducing overhead. By indicating the availability indication via a paging PDCCH or PEI when no UE is paged, the network can update availability indication even when no UE is paged, which reduces overhead relative to only updating availability indication when a UE is paged (thereby forcing the network to continue using a given TRS configuration until a UE can be paged). By applying the availability indication based at least in part on an offset, ambiguity as to when availability indication should be applied is reduced at the UE, which improves accuracy of tracking loop updates.

Some aspects described herein relate to a method of wireless communication performed by a user equipment (UE). The method may include receiving an availability indication associated with a tracking reference signal (TRS). The method may include monitoring for the TRS based at least in part on the availability indication and a validity duration, wherein the validity duration is based at least in part on at least one of, the availability indication indicating that at least one configured TRS resource set is available, an indicator in the availability indication, or a time at which the availability indication is received. The method may include performing synchronization or frequency tracking based at least in part on the TRS.

Some aspects described herein relate to a method of wireless communication performed by a user equipment (UE). The method may include receiving a first availability indication indicating first availability information associated with a tracking reference signal (TRS). The method may include monitoring for the TRS in accordance with the first availability information. The method may include receiving, while monitoring for the TRS in accordance with the first availability information, a second availability indication indicating second availability information associated with the TRS. The method may include monitoring for the TRS, or ceasing monitoring for the TRS, in accordance with the second availability information.

Some aspects described herein relate to a method of wireless communication performed by a user equipment (UE). The method may include receiving an availability indication associated with a tracking reference signal (TRS), wherein the availability indication is received in a paging early indication (PEI) physical downlink control channel (PDCCH) or a paging PDCCH that indicates that no UE is paged. The method may include monitoring for the TRS, or ceasing monitoring for the TRS, in accordance with the availability indication.

Some aspects described herein relate to a method of wireless communication performed by a user equipment (UE). The method may include receiving an availability indication associated with a tracking reference signal (TRS). The method may include monitoring one or more TRS resource sets in accordance with the availability indication, wherein the TRS starts at a time after the availability indication is received in accordance with a time offset or an application delay. The method may include performing synchronization or frequency tracking based at least in part on the TRS.

Some aspects described herein relate to a user equipment (UE) for wireless communication. The user equipment may include a memory and one or more processors coupled to the memory. The one or more processors may be configured to receive an availability indication associated with a tracking reference signal (TRS). The one or more processors may be configured to monitor for the TRS based at least in part on the availability indication and a validity duration, wherein the validity duration is based at least in part on at least one of. The one or more processors may be configured to perform synchronization or frequency tracking based at least in part on the TRS.

Some aspects described herein relate to a user equipment (UE) for wireless communication. The user equipment may include a memory and one or more processors coupled to the memory. The one or more processors may be configured to receive a first availability indication indicating first availability information associated with a tracking reference signal (TRS). The one or more processors may be configured to monitor for the TRS in accordance with the first availability information. The one or more processors may be configured to receive, while monitoring for the TRS in accordance with the first availability information, a second availability indication indicating second availability information associated with the TRS. The one or more processors may be configured to monitor for the TRS, or ceasing monitoring for the TRS, in accordance with the second availability information.

Some aspects described herein relate to a user equipment (UE) for wireless communication. The user equipment may include a memory and one or more processors coupled to the memory. The one or more processors may be configured to receive an availability indication associated with a tracking reference signal (TRS), wherein the availability indication is received in a paging early indication (PEI) physical downlink control channel (PDCCH) or a paging PDCCH that indicates that no UE is paged. The one or more processors may be configured to monitor for the TRS, or ceasing monitoring for the TRS, in accordance with the availability indication.

Some aspects described herein relate to a user equipment (UE) for wireless communication. The user equipment may include a memory and one or more processors coupled to the memory. The one or more processors may be configured to receive an availability indication associated with a tracking reference signal (TRS). The one or more processors may be configured to monitor one or more TRS resource sets in accordance with the availability indication, wherein the TRS starts at a time after the availability indication is received in accordance with a time offset or an application delay. The one or more processors may be configured to perform synchronization or frequency tracking based at least in part on the TRS.

Some aspects described herein relate to a non-transitory computer-readable medium that stores a set of instructions for wireless communication by a user equipment (UE). The set of instructions, when executed by one or more processors of the UE, may cause the UE to receive an availability indication associated with a tracking reference signal (TRS). The set of instructions, when executed by one or more processors of the UE, may cause the UE to monitor for the TRS based at least in part on the availability indication and a validity duration, wherein the validity duration is based at least in part on at least one of. The set of instructions, when executed by one or more processors of the UE, may cause the UE to perform synchronization or frequency tracking based at least in part on the TRS.

Some aspects described herein relate to a non-transitory computer-readable medium that stores a set of instructions for wireless communication by an UE. The set of instructions, when executed by one or more processors of the UE, may cause the UE to receive a first availability indication indicating first availability information associated with a tracking reference signal (TRS). The set of instructions, when executed by one or more processors of the UE, may cause the UE to monitor for the TRS in accordance with the first availability information. The set of instructions, when executed by one or more processors of the UE, may cause the UE to receive, while monitoring for the TRS in accordance with the first availability information, a second availability indication indicating second availability information associated with the TRS. The set of instructions, when executed by one or more processors of the UE, may cause the UE to monitor for the TRS, or ceasing monitoring for the TRS, in accordance with the second availability information.

Some aspects described herein relate to a non-transitory computer-readable medium that stores a set of instructions for wireless communication by an UE. The set of instructions, when executed by one or more processors of the UE, may cause the UE to receive an availability indication associated with a tracking reference signal (TRS), wherein the availability indication is received in a paging early indication (PEI) physical downlink control channel (PDCCH) or a paging PDCCH that indicates that no UE is paged. The set of instructions, when executed by one or more processors of the UE, may cause the UE to monitor for the TRS, or ceasing monitoring for the TRS, in accordance with the availability indication.

Some aspects described herein relate to a non-transitory computer-readable medium that stores a set of instructions for wireless communication by an UE. The set of instructions, when executed by one or more processors of the UE, may cause the UE to receive an availability indication associated with a tracking reference signal (TRS). The set of instructions, when executed by one or more processors of the UE, may cause the UE to monitor one or more TRS resource sets in accordance with the availability indication, wherein the TRS starts at a time after the availability indication is received in accordance with a time offset or an application delay. The set of instructions, when executed by one or more processors of the UE, may cause the UE to perform synchronization or frequency tracking based at least in part on the TRS.

Some aspects described herein relate to an apparatus for wireless communication. The apparatus may include means for receiving an availability indication associated with a tracking reference signal (TRS). The apparatus may include means for monitoring for the TRS based at least in part on the availability indication and a validity duration, wherein the validity duration is based at least in part on at least one of, the availability indication indicating that at least one configured TRS resource set is available, an indicator in the availability indication, or a time at which the availability indication is received. The apparatus may include means for performing synchronization or frequency tracking based at least in part on the TRS.

Some aspects described herein relate to an apparatus for wireless communication. The apparatus may include means for receiving a first availability indication indicating first availability information associated with a tracking reference signal (TRS). The apparatus may include means for monitoring for the TRS in accordance with the first availability information. The apparatus may include means for receiving, while monitoring for the TRS in accordance with the first availability information, a second availability indication indicating second availability information associated with the TRS. The apparatus may include means for monitoring for the TRS, or ceasing monitoring for the TRS, in accordance with the second availability information.

Some aspects described herein relate to an apparatus for wireless communication. The apparatus may include means for receiving an availability indication associated with a tracking reference signal (TRS), wherein the availability indication is received in a paging early indication (PEI) physical downlink control channel (PDCCH) or a paging PDCCH that indicates that no UE is paged. The apparatus may include means for monitoring for the TRS, or ceasing monitoring for the TRS, in accordance with the availability indication.

Some aspects described herein relate to an apparatus for wireless communication. The apparatus may include means for receiving an availability indication associated with a tracking reference signal (TRS). The apparatus may include means for monitoring one or more TRS resource sets in accordance with the availability indication, wherein the TRS starts at a time after the availability indication is received in accordance with a time offset or an application delay. The apparatus may include means for performing synchronization or frequency tracking based at least in part on the TRS.

Aspects generally include a method, apparatus, system, computer program product, non-transitory computer-readable medium, user equipment, base station, wireless communication device, and/or processing system as substantially described with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network.

FIG. 2 is a diagram illustrating an example of a base station in communication with a user equipment (UE) in a wireless network.

FIGS. 3A-3B are diagrams illustrating examples of paging configurations.

FIG. 4 is a diagram illustrating an example of a tracking reference signal (TRS) and a corresponding validity duration.

FIG. 5 is a diagram illustrating an example of selective application of a validity duration.

FIG. 6 is a diagram illustrating an example of a validity duration based at least in part on an indicator or a time associated with an availability indication (availability indication).

FIG. 7 is a diagram illustrating an example of indication of an availability indication via a paging PDCCH or paging early indication (PEI) when no UE is paged.

FIG. 8 is a diagram illustrating an example of applying availability information after a time offset or application delay.

FIGS. 9-12 are flowcharts of example methods of wireless communication.

FIG. 13 is a diagram of an example apparatus for wireless communication.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

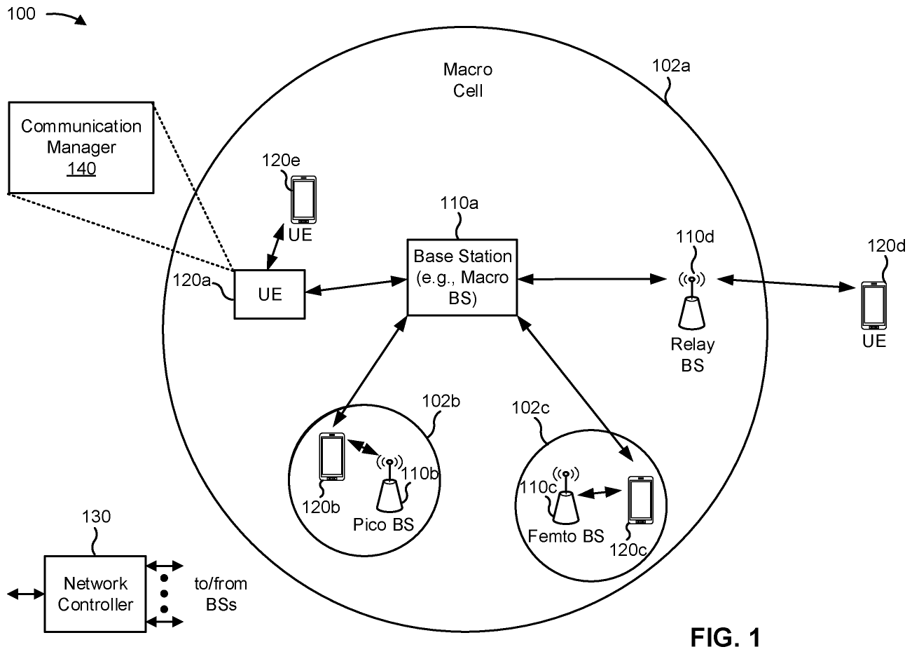

FIG. 1 is a diagram illustrating a wireless network 100 in which aspects of the present disclosure may be practiced. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an availability indication associated with a tracking reference signal (TRS); monitor for the TRS based at least in part on the availability indication and a validity duration, wherein the validity duration is based at least in part on at least one of: the availability indication indicating that at least one configured TRS resource set is available, an indicator in the availability indication, or a time at which the availability indication is received; and perform synchronization or frequency tracking based at least in part on the TRS. Additionally, or alternatively, the communication manager 140 may perform one or more other operations described herein.

In some aspects, the communication manager 140 may receive a first availability indication indicating first availability information associated with a tracking reference signal (TRS); monitor for the TRS in accordance with the first availability information; receive, while monitoring for the TRS in accordance with the first availability information, a second availability indication indicating second availability information associated with the TRS; and monitor for the TRS, or ceasing monitoring for the TRS, in accordance with the second availability information. Additionally, or alternatively, the communication manager 140 may perform one or more other operations described herein.

In some aspects, the communication manager 140 may receive an availability indication associated with a tracking reference signal (TRS), wherein the availability indication is received in a paging early indication (PEI) physical downlink control channel (PDCCH) or a paging PDCCH that indicates that no UE is paged; and monitor for the TRS, or ceasing monitoring for the TRS, in accordance with the availability indication. Additionally, or alternatively, the communication manager 140 may perform one or more other operations described herein.

In some aspects, the communication manager 140 may receive an availability indication associated with a tracking reference signal (TRS); monitor one or more TRS resource sets in accordance with the availability indication, wherein the TRS starts at a time after the availability indication is received in accordance with a time offset or an application delay; and perform synchronization or frequency tracking based at least in part on the TRS. Additionally, or alternatively, the communication manager 140 may perform one or more other operations described herein.

As indicated above, FIG. 1 is provided as an example. Other examples may differ from what is described with regard to FIG. 1.

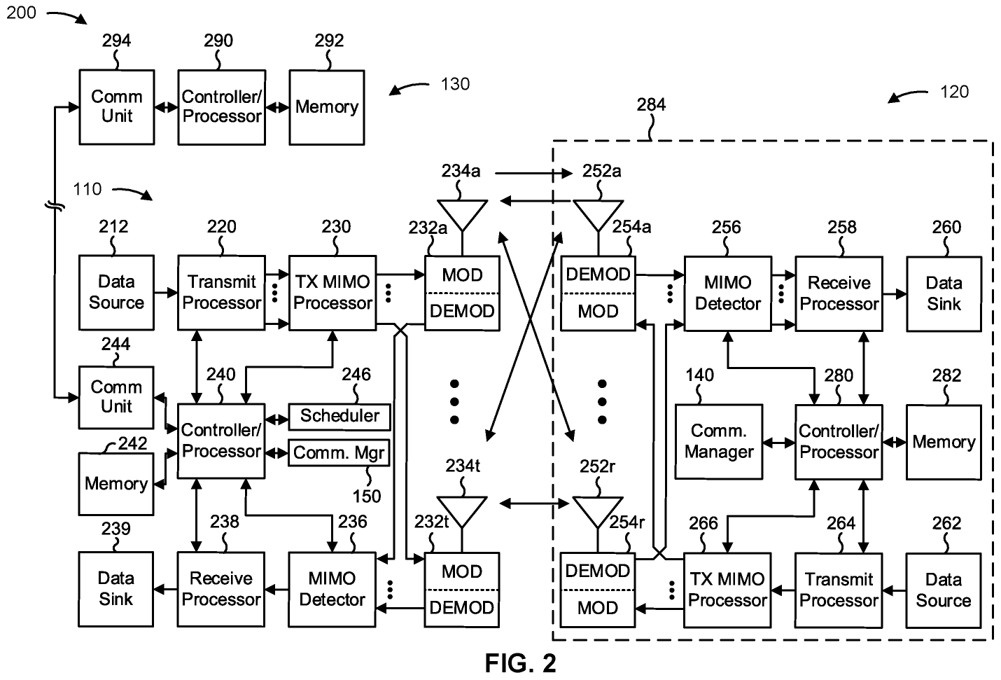

FIG. 2 is a diagram illustrating an example 200 of a base station 110 in communication with a UE 120 in a wireless network 100. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

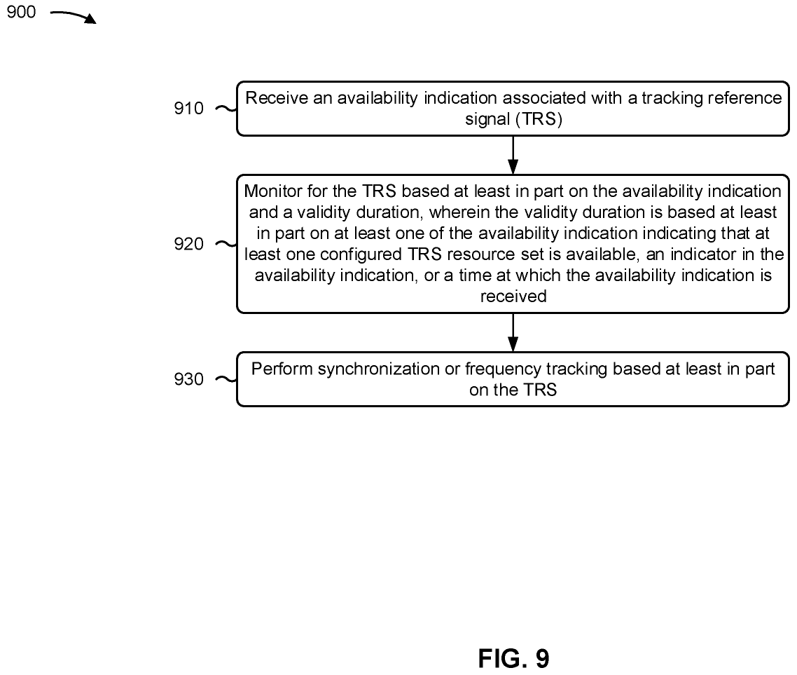

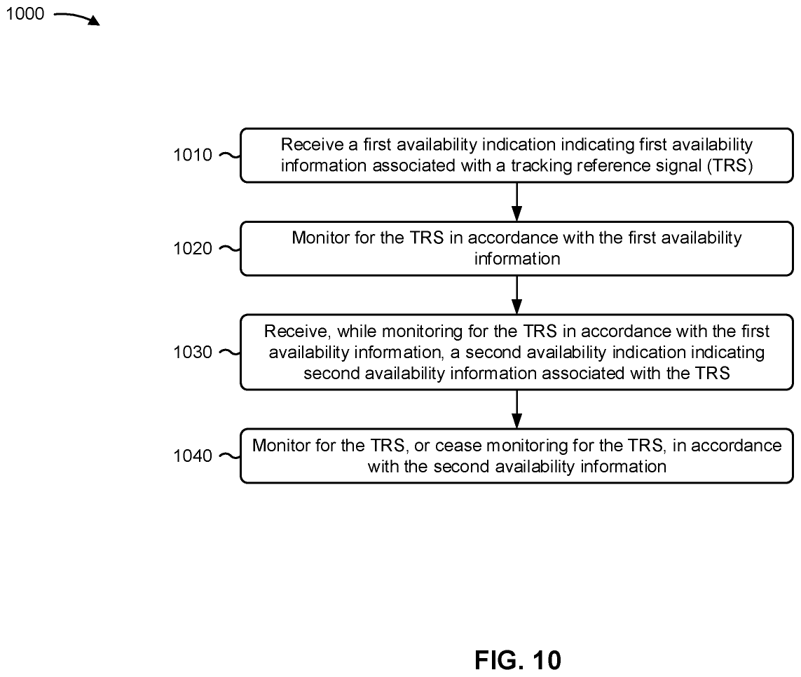

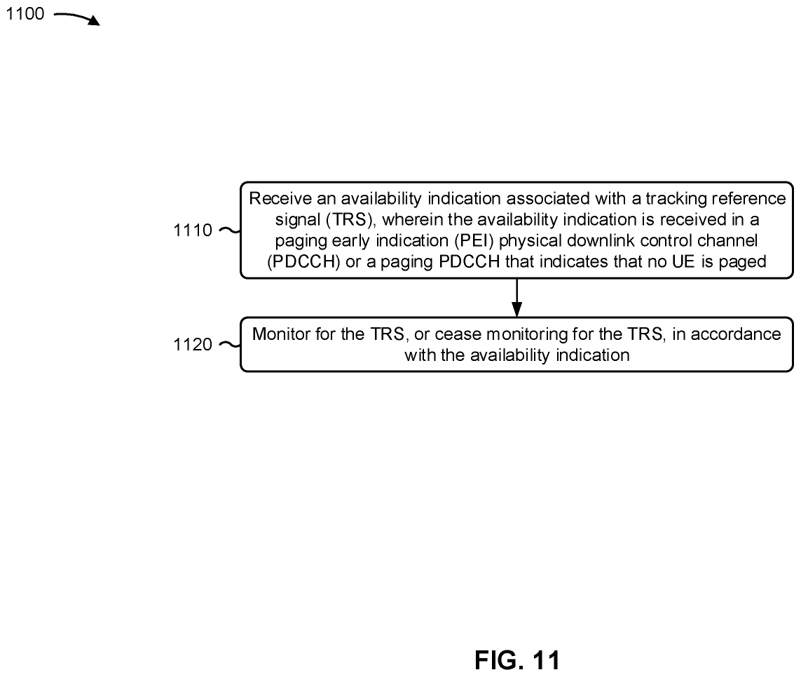

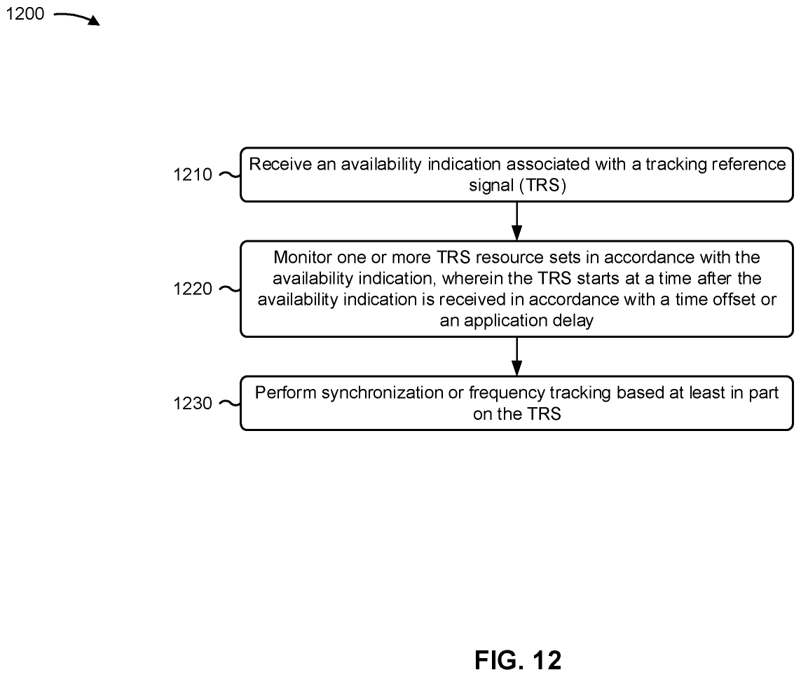

The controller/processor 240 of the base station 110, the controller/processor 280 of the UE 120, and/or any other component(s) of FIG. 2 may perform one or more techniques associated with tracking reference signaling, as described in more detail elsewhere herein. For example, the controller/processor 240 of the base station 110, the controller/processor 280 of the UE 120, and/or any other component(s) of FIG. 2 may perform or direct operations of, for example, method 900 of FIG. 9, method 1000 of FIG. 10, method 1100 of FIG. 11, method 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, method 900 of FIG. 9, method 1000 of FIG. 10, method 1100 of FIG. 11, method 1200 of FIG. 12, and/or other processes as described herein. In some examples, executing instructions may include running the instructions, converting the instructions, compiling the instructions, and/or interpreting the instructions, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

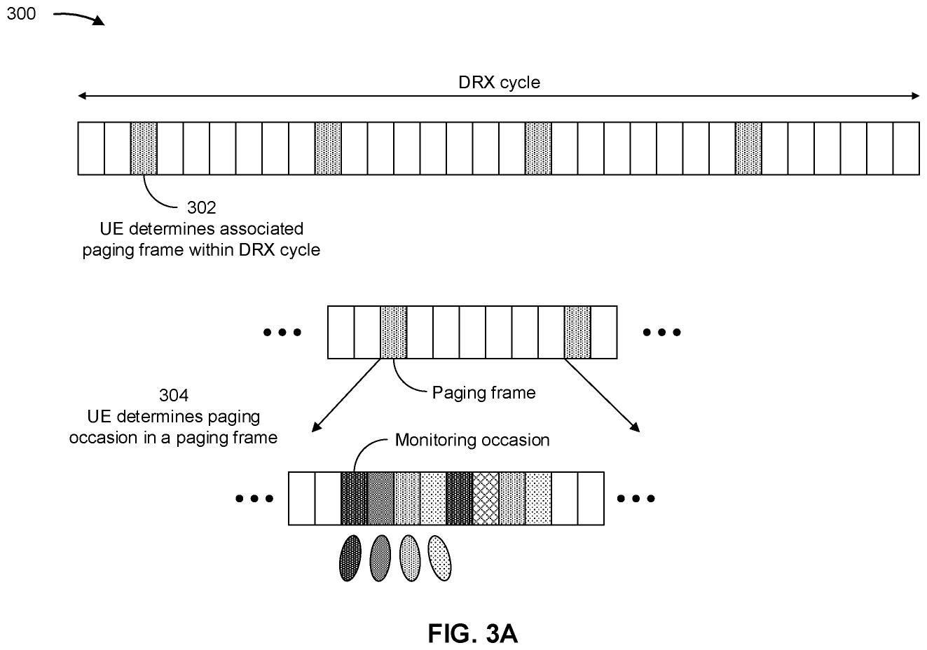

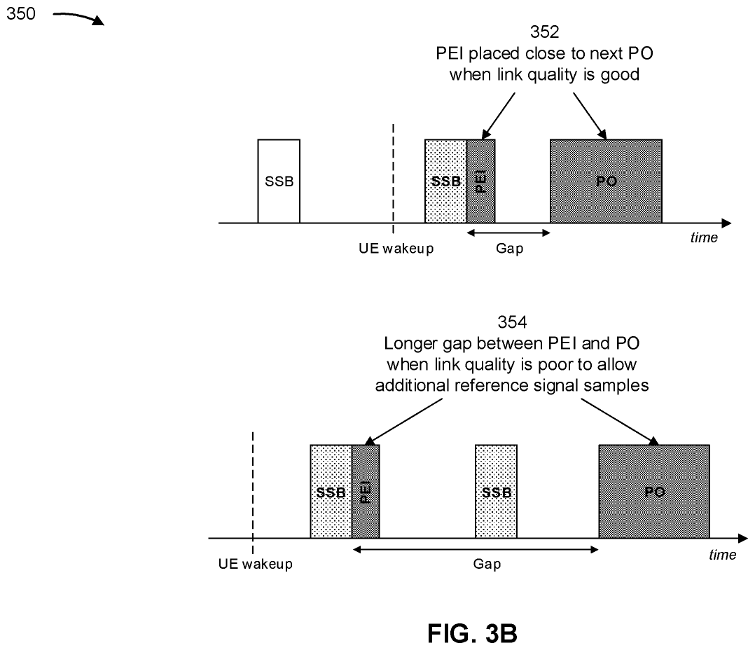

FIGS. 3A-3B are diagrams illustrating examples 300, 350 of paging configurations. For example, FIG. 3A illustrates an example 300 of a paging reception configuration in which a UE in an idle or inactive mode monitors a control channel (e.g., a PDCCH) during a PO within a paging frame. The paging frame may be configured for the UE to determine whether a page is scheduled for any UE during the PO. For example, at 302, the UE may determine a paging frame within a discontinuous reception (DRX) cycle configured for the UE. The paging frame may generally represent a reference frame or a starting frame for a PO associated with the UE, because a PO associated with a paging frame may start in the paging frame or after the paging frame due to multi-beam operation and/or PO repetition.

Accordingly, in some aspects, a base station may configure paging reception for the UE by indicating a number of radio frames in a DRX cycle. In general, the DRX cycle may be configured to include 32, 64, 128, or 256 radio frames, and the base station may further configure an interval between adjacent paging frames (e.g., 1, 2, 4, 8, or 16 radio frames) and a time domain offset in frames for paging frames (e.g., from zero to N frames, where N is one less than the interval between adjacent paging frames). In some aspects, a number of paging frames in each DRX cycle may be based at least in part on the number of radio frames and the interval between adjacent paging frames. For example, in FIG. 3A, the DRX cycle includes 32 radio frames that are 10 milliseconds each, the interval between adjacent paging frames is 8 radio frames (or 80 milliseconds), and the time domain offset is 6 radio frames, resulting in four (4) paging frames in the DRX cycle. The UE may determine, among the various paging frames in the DRX cycle, the particular paging frame that is associated with the UE based on an identifier assigned to the UE.

As further shown in FIG. 3, at 304, the UE may determine a PO in a paging frame that is associated with the UE, and the UE may monitor the control channel for a paging PDCCH associated with the UE during the PO associated with the UE. For example, the base station may configure a number of POs per paging frame (e.g., 1, 2, or 4 POs per paging frame), and the UE may determine a PO index (iₛ) associated with the UE based on the identifier assigned to the UE. In general, each PO may contain a set of S*X consecutive PDCCH monitoring occasions, where S is a number of actual transmitted synchronization signal blocks (SSBs) indicated in a SIB that carries information to enable access to a cell provided by the base station (e.g., SIB1) and X is a number of PDCCH monitoring occasions per SSB in a PO (e.g., 1, 2, 3, or 4). The starting PDCCH monitoring occasion number of PO iₛ is either configured by the base station or based on a value of iₛ*S *X, where the [x*S+K]th PDCCH monitoring occasion for paging in the PO corresponds to the K th transmitted SSB, where x=0, 1, . . . , X−1, K=1, 2, . . . , S. A PO is a set of resources (e.g., a set of time and/or frequency resources) in which a UE is configured to monitor for a paging PDCCH. A PDCCH monitoring occasion is a set of resources in which a UE is configured to monitor a PDCCH. As used herein, “monitoring a PDCCH” may refer to attempting to decode a PDCCH communication (such as a paging PDCCH or a PEI PDCCH) via the PDCCH in one or more PDCCH monitoring occasions.

In some aspects, when the UE is in an idle or inactive mode, the UE may wake up from the sleep state once in every DRX cycle during the PO associated with the UE, which is determined in the manner described above. At the time that the UE wakes up from the sleep state, the UE is generally unaware of whether there will be a page for the UE during the PO. Consequently, when the UE wakes up during the PO associated with the UE, an entire receive chain is activated to enable the UE to receive and decode a page that may be carried on a physical downlink shared channel (PDSCH). This may increase power consumption at the UE, as components needed to receive and decode the paging PDSCH may not need to be activated if there is no page scheduled for the UE.

Accordingly, in some cases, a wireless network may support a paging early indication (PEI), sometimes referred to as a wakeup signal (WUS) for idle and inactive modes, to improve power efficiency associated with paging reception at a UE. For example, as shown in FIG. 3B, the PEI (or WUS) is a special signal that a base station transmits to a UE before the PO associated with the UE to indicate whether the UE should wake up to process a paging PDCCH. In this way, the UE may monitor only a PDCCH to determine whether the base station transmitted a PEI to indicate that the UE is to wake up to process a paging PDCCH, and may return to a low-power sleep state in cases where a PEI is not transmitted and/or a PEI indicates that there is no paging PDCCH intended for any UE of all UEs or a subgroup of UEs in the associated PO. Alternatively, when the PEI is transmitted to indicate that the UE should wake up to process a paging PDCCH, the UE may fully wake up to receive the PDSCH carrying the paging message if the paging PDCCH indicates so. In such cases, after the UE receives a PEI indicating that there is a paging PDSCH to decode, the UE may additionally measure one or more reference signals (e.g., one or more SSBs, tracking reference signals (TRSs), and/or channel state information reference signals (CSI-RSs)) to synchronize with the base station and improve decoding of the PDSCH carrying the paging message. For example, as shown at 352, the PEI may be placed relatively close to the next PO in cases where the channel between the base station and the UE has a good link quality in the entire cell, as remaining time after the UE processes the reference signal transmissions may not be long enough to merit a transition to deep sleep (e.g., one reference signal sample may be enough to reliably decode the paging PDSCH). Otherwise, as shown at 354, a longer gap may be provided between the PEI and the next PO to allow the UE to obtain multiple reference signal samples between the PEI and the next PO when the quality of the channel between the base station and the UE can be poor for the UE. The PEI may be based at least in part on UE subgrouping, which splits UEs associated with a PO into multiple subgroups, and may separately indicate whether UEs of a subgroup should process the paging PDCCH of a given PO.

In this way, the PEI enables the UE to wake up in two stages, which include a first stage in which the UE activates only a portion of a receive chain to monitor the PDCCH for the PEI and a second stage in which the UE activates a remaining portion of the receive chain to receive and decode the paging PDSCH (and/or measure or sample reference signals) if the PEI indicates that there is a page for the UE in the associated PO.

As indicated above, FIGS. 3A-3B are provided as an example. Other examples may differ from what is described with regard to FIGS. 3A-3B.

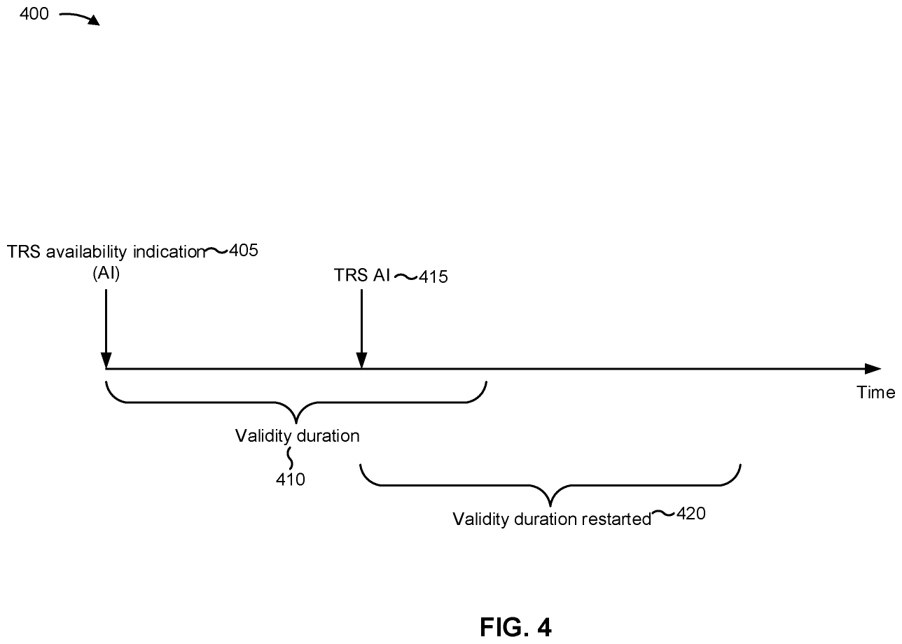

FIG. 4 is a diagram illustrating an example 400 of a tracking reference signal (TRS) and a corresponding validity duration.

A TRS is a downlink signal that may be used to perform time synchronization or frequency synchronization with an area. The UE may receive the TRS and may compare the resources on which the TRS is received to resources on which the TRS was expected to be received to perform time and frequency synchronization and tracking. For example, a UE may use the TRS to update a tracking loop, which tracks changes to a frame timing of the network and an estimated time of arrival (TOA) of signals to be received by the UE. The UE may use the tracking loop updated by TRSs to perform operations quickly when transitioning from an idle or inactive state to a connected state. The base station may utilize the TRS to communicate with the UE. The base station may transmit a radio resource control (RRC) message to a connected UE (e.g., a UE operating in an RRC state of RRC_CONNECTED). The RRC message may include configuration information for the TRS, or a TRS configuration. The UE may receive the RRC message and may store the TRS configuration. The UE may perform an action causing phase discontinuity, such as bandwidth part (BWP) switching, BWP activation, carrier aggregation, cell activation (e.g., secondary cell activation), multi-TRP switching, multi-panel switching, and/or beam changing, among other examples, where the UE uses the TRS for fast synchronization and fine time/frequency tracking. In some examples, the UE may use a TRS for automatic gain control (AGC) operations.

In some cases, UEs operating in an idle state or an inactive state may use synchronization signal blocks (SSBs) transmitted by a base station for radio resource management (RRM) measurements, to update a tracking loop, and/or to perform AGC operations, among other examples. However, SSB transmissions by the base station may be sparse (e.g., SSBs may be transmitted by the base station with a relatively large periodicity). Therefore, in some cases, a base station may transmit a TRS to a UE when the UE is in an idle or inactive state to supplement the SSBs for RRM measurements, tacking loop updates, and/or AGC operations, among other examples. The TRS configuration information received by the UE may indicate the resources on which the base station may transmit the TRS. For example, a UE operating in an idle state (e.g., an RRC_IDLE state) or an inactive state (e.g., an RRC_INACTIVE state) may use a TRS transmitted by the base station for RRM measurements, tracking loop updates, and/or AGC operations, among other examples.

The base station may indicate configuration information for TRSs in a broadcast signal, such as a system information block (SIB), to enable UEs operating in an idle mode or an inactive mode to use the TRSs (e.g., indicated by the configuration information) for RRM measurements, tacking loop updates, and/or AGC operations, among other examples. As described above, the network (e.g., the base station) may dynamically determine whether to transmit configured TRSs. However, the configuration of TRSs may be a static configuration (e.g., may be indicated in system information or a SIB). Therefore, dynamically updating the configuration information to indicate TRSs that will be transmitted by the base station (e.g., dynamically updating the SIB to reconfigure TRS resources or TRS resource sets that will actually be transmitted by the base station) may be associated with overhead and/or significant delay or latency (e.g., because the configuration is a static configuration).

Therefore, the base station may transmit a TRS availability indication that indicates, from a set of configured TRS resources or a set of configured TRS resource sets, which TRSs are to be transmitted by the base station. The TRS availability indication may be a Layer 1 (L1) (e.g., a physical (PHY) layer) signal. For example, the TRS availability indication may be a paging signal. In some examples, the TRS availability indication may be transmitted via the PDCCH. The TRS availability indication signaling may be a paging PDCCH signal and/or a PEI signal, among other examples. A PEI signal may function as a wake-up signal (WUS) for the idle mode or the inactive mode. For example, the PEI signal may indicate whether a UE is to process a paging PDCCH (e.g., before a paging occasion associated with the paging signal). The TRS availability indication may be included in reserved bits (e.g., reserved as defined, or otherwise fixed, by a wireless communication standard, such as the 3GPP) of a paging PDCCH signal. For example, the TRS availability indication signal may include separate indications for each of the configured TRS resources, each of the configured TRS resource sets or each group of the configured TRS resource sets. For example, a TRS availability indication signal may include a first indication that indicates whether a first TRS resource, a first TRS resource set or a first group of TRS resource sets is to be transmitted by the base station, a second indication that indicates whether a second TRS resource, a second TRS resource set or a second group of TRS resource sets is to be transmitted by the base station, a third indication that indicates whether a third TRS resource, a third TRS resource set or a third group of TRS resource sets is to be transmitted by the base station, and so on. In some examples, the above-described indications may be bits. In some examples, a TRS availability indication signal may include an indication of whether a TRS resource, TRS resource set or group of TRS resource sets is available (e.g., transmitted by the base station) or unavailable (e.g., not transmitted by the base station).

An availability indication may be associated with a validity duration. For example, an availability indication 405 may be associated with a validity duration 410. The length of the validity duration may be configured by the network. Within the validity duration, the availability indication received by a UE remains valid. That is, the UE can assume that the availability indication does not change within the validity duration. Once the validity duration expires, the UE may not assume that a TRS is transmitted. The validity duration provides for a TRS to be automatically deactivated so that TRSs do not need to be continually transmitted if no PEIs or paging PDCCHs are transmitted to a UE. The reference point for the start of the validity duration (that is, the time at which the validity duration starts) may be defined as the start of the first paging frame of the current DRX cycle where the UE receives the availability indication. If another availability indication 415 is received before the end of the validity duration 410, the validity duration 410 may restart as a validity duration 420.

As indicated above, FIG. 4 is provided as an example. Other examples may differ from what is described with regard to FIG. 4.

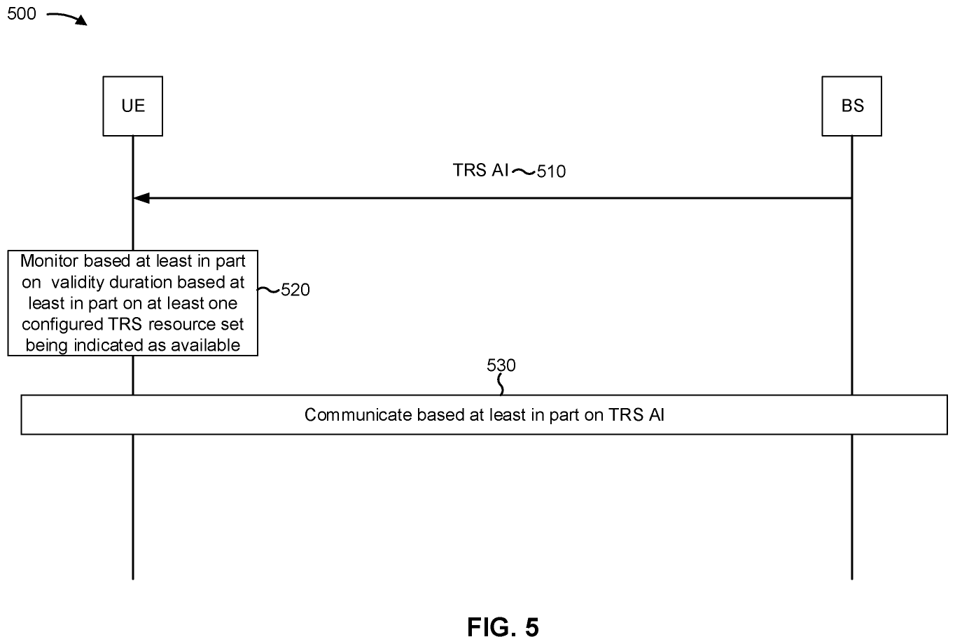

FIG. 5 is a diagram illustrating an example 500 of selective application of a validity duration. As shown, example 500 includes a UE (e.g., UE 120) and a base station (e.g., base station 110).

At 510, the UE may receive, and the base station may transmit, an availability indication associated with tracking reference signaling (shown as “TRS AI”). In some aspects, the availability indication may be transmitted via a PEI (e.g., a PEI PDCCH). In some other aspects, the availability indication may be transmitted via a paging PDCCH. As mentioned above, the availability indication may include one or more indications of whether one or more groups of TRS resource sets are available. For example, if there are N groups of TRS resource sets configured for the UE, the availability indication may include N indications (e.g., one for each of the N groups of TRS resource sets). In example 500, the availability indication indicates that at least one configured TRS resource set is available. Thus, it may be said that the availability indication indicates that any TRS resource set is available.

At 520, the UE may monitor for the TRS in accordance with a validity duration based at least in part on the at least one TRS resource set being indicated as available. For example, the availability indication may indicate a start of a validity duration associated with the availability indication if the availability indication indicates that at least one configured TRS resource will be transmitted. If the availability indication indicates that no configured TRS resource set will be transmitted (e.g., that no TRS resource set is available), then a validity duration may not be applied. Thus, the UE and the network can selectively apply a validity duration based at least in part on whether the availability indication indicates that any TRS resource is available. This may be beneficial at least for the purpose of avoiding unintended application or extension of a validity duration. Furthermore, applying the validity duration only if at least one TRS resource set is indicated as available avoids ambiguity as to whether a validity duration should be applied if no TRS resource set is indicated as available, which might otherwise lead to a validity duration being applied when no TRS resource set is available (which may not be particularly useful and which may prevent subsequent activation of one or more TRS resource sets during the validity duration).

In some aspects, each indication of the availability indication may be associated with a respective validity duration. For example, the availability indication may include a first indication associated with a first group of TRS resource sets, a second indication associated with a second group of TRS resource sets, and a third indication associated with a third group of TRS resource sets. In this example, the first indication may be associated with a first validity duration, the second indication may be associated with a second validity duration, and the third indication may be associated with a third validity duration. If the first indication indicates that the first group of TRS resource sets is activated, the UE may observe a validity duration for the first group of TRS resource sets. If the second indication indicates that the second group of TRS resource sets is activated, the UE may observe a validity duration for the second group of TRS resource sets. If the third indication indicates that the third group of TRS resource sets is activated, the UE may observe a validity duration for the third group of TRS resource sets. Thus, groups of TRS resource sets can have unsynchronized availability or unavailability, which provides improved flexibility of deactivation and activation for different TRS resource sets via the same availability indication.

In some aspects, a validity duration may be defined jointly for all groups of TRS resource sets associated with the availability indication. For example, the validity duration may be defined jointly for all indications of the availability indication. In this example, the validity duration may apply to all groups of TRS resource sets associated with the availability indication so long as the availability indication indicates that at least one group of TRS resource sets is available. Providing separate validity durations for each group of TRS resource sets may provide increased flexibility for activation of different groups of TRS resource sets, whereas using a jointly defined validity duration may simplify implementation at the UE.

At 530, the UE and the base station may communicate based at least in part on the availability indication. For example, the base station may transmit one or more TRSs in one or more TRS resource sets indicated as available by the availability indication. As another example, the UE may monitor for the one or more TRSs in the one or more TRS resource sets. As yet another example, the UE may cease monitoring the one or more TRSs after the validity duration has elapsed.

As used herein, “monitoring for a TRS” or “monitoring a TRS” may include attempting to detect a TRS in one or more TRS resource sets. “Monitoring for a TRS” or “monitoring a TRS” may additionally or alternatively include identifying a signal sample or a TRS in one or more TRS resource sets. The UE may use the signal sample or detected/identified TRS to perform synchronization (e.g., time synchronization or re-synchronization) or frequency tracking, such as by identifying variations in time and/or frequency relative to a target time and/or frequency.

As indicated above, FIG. 5 is provided as an example. Other examples may differ from what is described with regard to FIG. 5.

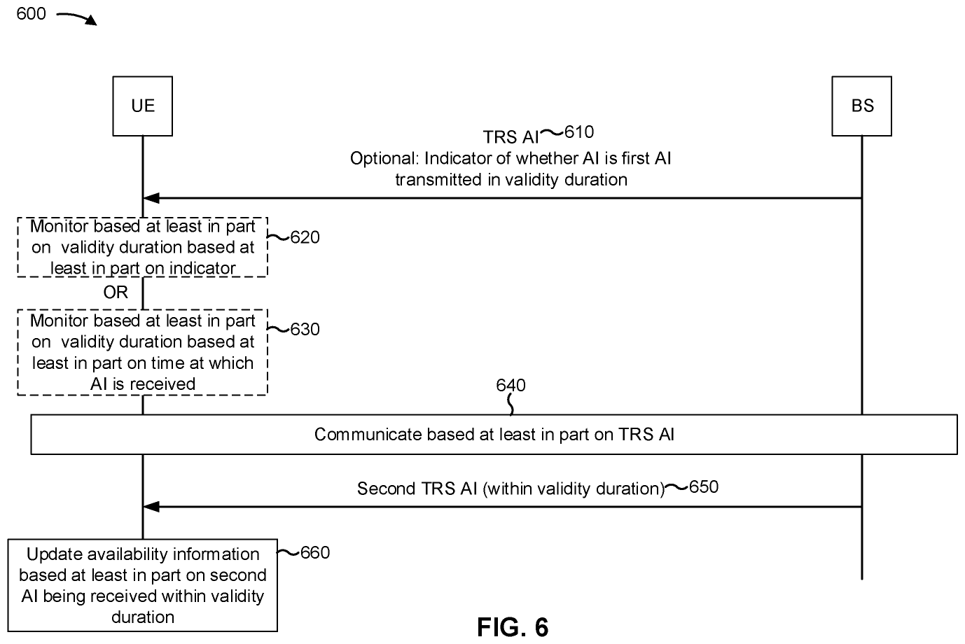

FIG. 6 is a diagram illustrating an example 600 of a validity duration based at least in part on an indicator or a time associated with an availability indication. As shown, example 600 includes a UE (e.g., UE 120) and a base station (e.g., base station 110).

At 610, the UE may receive, and the base station may transmit, an availability indication associated with tracking reference signaling (shown as “TRS AI”). In some aspects, the availability indication may be transmitted via a PEI (e.g., a PEI PDCCH). In some other aspects, the availability indication may be transmitted via a paging PDCCH. As mentioned above, the availability indication may include one or more indications of whether one or more groups of TRS resource sets are available.

In some aspects, and as shown, the availability indication may include or be associated with an indicator. The indicator may identify whether the availability indication is a first availability indication transmitted in a validity duration. In this way, the base station may indicate whether an availability indication is the first availability indication that is associated with the start of a validity duration. In some aspects, the indicator includes a bit of a bitmap of the availability indication. For example, the base station may use one or more separate bits in a bitmap of the availability indication (e.g., the bitmap that provides one or more indications of one or more available groups of TRS resource sets, or a different bitmap) to indicate whether the availability indication is the first availability indication transmitted in the validity duration. In such examples, one bit (e.g., the first bit of the bitmap) set to a first value may indicate that the availability indication is the first availability indication, and the bit set to a second value may indicate that the availability indication is not the first availability indication. Using one or more bits of the bitmap may be simpler than some other approaches for the indicator. The UE may monitor for TRS in accordance with a validity duration if the bit is set to the first value. In some aspects, the indicator identifies whether the availability indication is the first availability indication transmitted in the validity duration by indicating whether a group of TRS resource sets is available, which may allow more bits to be used for indication of groups of TRS resource sets that are available relative to the bitmap-based approach. For example, the base station may indicate that one or more or all groups of TRS resource sets are not available in all availability indications except for the first availability indication that is associated with the start of the validity duration. In other words, if a first availability indication activates a particular group of TRS resource sets and a validity duration, a second availability indication transmitted within the validity duration may indicate the particular group of TRS resource sets as not available.

At 620, the UE may optionally monitor for a TRS in accordance with the validity duration based at least in part on the indicator. For example, the UE may monitor for a TRS in accordance with the validity duration if the indicator identifies the availability indication as a first availability indication transmitted in (or in association with) a validity duration.

At 630, the UE may optionally monitor for a TRS in accordance with the validity duration based at least in part on a time at which the availability indication is received. For example, the UE may monitor for a TRS in accordance with the validity duration based at least in part on the availability indication being received at least a threshold length of time after a prior availability indication. The threshold length of time may be based at least in part on at least one of an integer multiple (n) of a length of the validity duration or a configurable offset (offset). For example, a first availability indication may be received at a first time and a second availability indication may be received at a second time. The base station may only transmit, and the UE may only expect to receive, the first availability indication and the second availability indication with different availability indication information (e.g., different indications of available groups of TRS resource sets), if the first availability indication and the second availability indication fall in two different durations associated with different values of n according to the formula: offset+n*validity duration, where offset is in units of a default paging cycle and can be configured as zero or omitted. In this example, the first availability indication and the second availability indication fall in the two different durations if the first time is in a first duration with a first value of n and the second time is in a second duration with a second value of n. Thus, the floating start of the configured validity duration is disabled, which reduces ambiguity regarding the start of the configured validity duration.

In some aspects, the UE may monitor for a TRS in accordance with the validity duration based at least in part on the time being within a validity duration of a prior availability indication. In such examples, the UE may receive a TRS in accordance with the availability indication based at least in part on the time being within the validity duration of the prior availability indication. For example, the UE may update availability information if an availability indication is received within a validity duration of a prior availability indication, as described in more detail in connection with the description of reference numbers 650 and 660, below.

At 640, the UE and the base station may communicate based at least in part on the availability indication. For example, the base station may transmit one or more TRSs in one or more TRS resource sets indicated as available by the availability indication. As another example, the UE may monitor for the one or more TRSs in the one or more TRS resource sets. As yet another example, the UE may cease monitoring the one or more TRSs after the validity duration has elapsed.

At 650, the UE may receive a second availability indication within the validity duration described at 620 or 630. At 660, in some aspects, the UE may update availability information associated with a TRS based at least in part on the second availability indication being received within the validity duration. For example, if the UE receives a second availability indication before a validity duration for the first availability indication expires, the second availability indication may be permitted to have different bitmap values (e.g., to indicate one or more different groups of TRS resource sets as available) than the first availability indication, and the UE may use availability information indicated by the second availability indication. In such examples, the first availability indication may become invalid after the validity duration expires if the UE does not receive the second availability indication within the validity duration. In some aspects, the UE may monitor for a TRS in accordance with the a second validity duration associated with the second availability indication. For example, the UE may start a second validity duration of a configured length (e.g., equal to the length of the first validity duration) based at least in part on receiving the second availability indication. In this way, the base station can update the availability information during a validity duration, which enables the base station to modify or cease TRS transmission during the validity duration. Thus, the efficiency of network resource usage may be improved.

As indicated above, FIG. 6 is provided as an example. Other examples may differ from what is described with regard to FIG. 6.

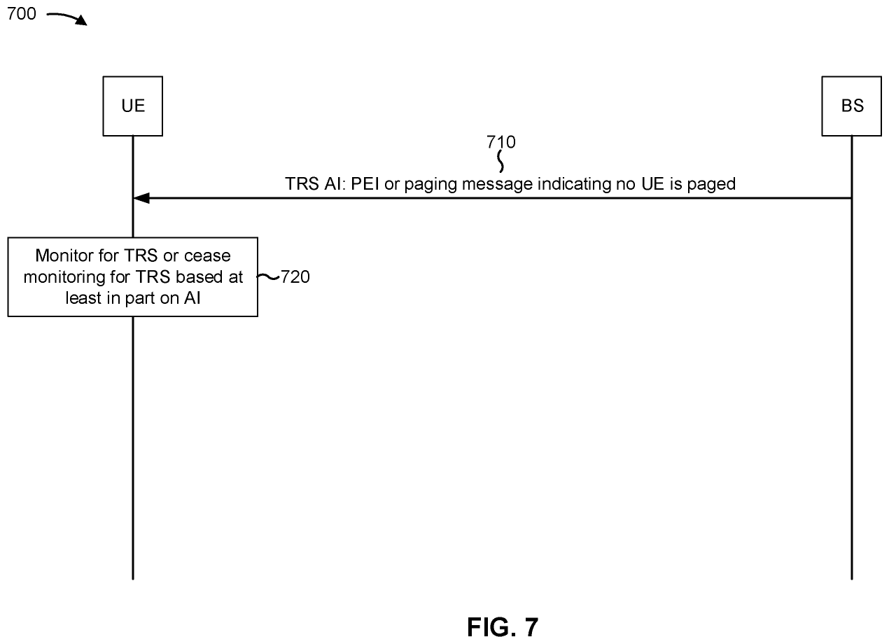

FIG. 7 is a diagram illustrating an example 700 of indication of an availability indication via a paging PDCCH or PEI when no UE is paged. As shown, example 700 includes a UE (e.g., UE 120) and a base station (e.g., base station 110).

In some aspects, the base station may ensure that, after a validity duration starts, all availability indications transmitted within the validity duration carry the same availability information as the availability indication that is associated with the validity duration for one or more indicated groups of TRS resource sets. In such examples, the UE may receive a first availability indication, and may use availability information indicated by the first availability indication. Upon receiving a second availability indication, the UE may apply availability information indicated by the second availability indication. For example, in some aspects, the UE may not trigger a validity duration. In some aspects, the validity duration may be maintained by the base station. For example, the UE may not explicitly follow the validity duration. In other words, the UE may communicate based at least in part on the second availability indication irrespective of a time at which the second availability indication was received relative to the first availability indication. For example, the UE may always use a last-received availability indication. Thus, complexity and processing resource usage at the UE may be reduced.

If no PEI or paging PDCCH is transmitted from the base station to the UE for a long period of time, and if a UE does not monitor for a TRS in accordance with a validity duration, the base station may be mandated to continue transmitting TRSs in accordance with a most recently transmitted availability indication, since no new availability indication can be transmitted to the UE. The techniques described in connection with FIG. 7 provide for a base station to transmit an availability indication even if a PEI or paging PDCCH does not indicate that any associated UE is paged.

At 710, the UE may receive, and the base station may transmit, an availability indication associated with TRS (shown as “TRS availability indication”). As further shown, the availability indication may be transmitted in or in association with a PEI or paging PDCCH. As shown, the PEI or the paging PDCCH may indicate that no UE, associated with the PEI or the paging PDCCH, is paged. For example, a short message indicator field of the paging PDCCH may indicate that no UE is paged (e.g., a particular value of the field, such as “00,” may indicate that neither a short message nor paging shared channel scheduling information is included in the paging PDCCH). As another example, a set of indicators of the PEI may all indicate that corresponding groups or subgroups of UEs are not paged.

In some aspects, the UE may expect to receive a PEI or paging PDCCH that does not page any UE if the TRS availability indication field indicates one or more available groups of TRS resource sets become unavailable. For example, in some aspects, the UE may receive a prior availability indication that indicates one or more available groups of TRS resource sets. The UE may subsequently receive a later availability indication that indicates that the one or more available groups of TRS resource sets are no longer available. The UE may update availability information in accordance with the later availability indication based at least in part on the later availability indication indicating that the one or more available groups of TRS resource sets are no longer available. If the later availability indication did not indicate that the one or more available groups of TRS resource sets are no longer available, then the UE may not update availability information, or may disregard the later availability indication. Thus, the paging PDCCH that does not page any UE can be restricted for use only to deactivate TRS resource sets.

At 720, the UE and the base station may communicate based at least in part on the availability indication. For example, the base station may transmit a TRS in accordance with the availability indication. As another example, the base station may cease transmitting a TRS in accordance with the availability indication. As yet another example, the UE may monitor for a TRS in accordance with the availability indication. As still another example, the UE may cease monitoring for a TRS in accordance with the availability indication.

As indicated above, FIG. 7 is provided as an example. Other examples may differ from what is described with regard to FIG. 7.

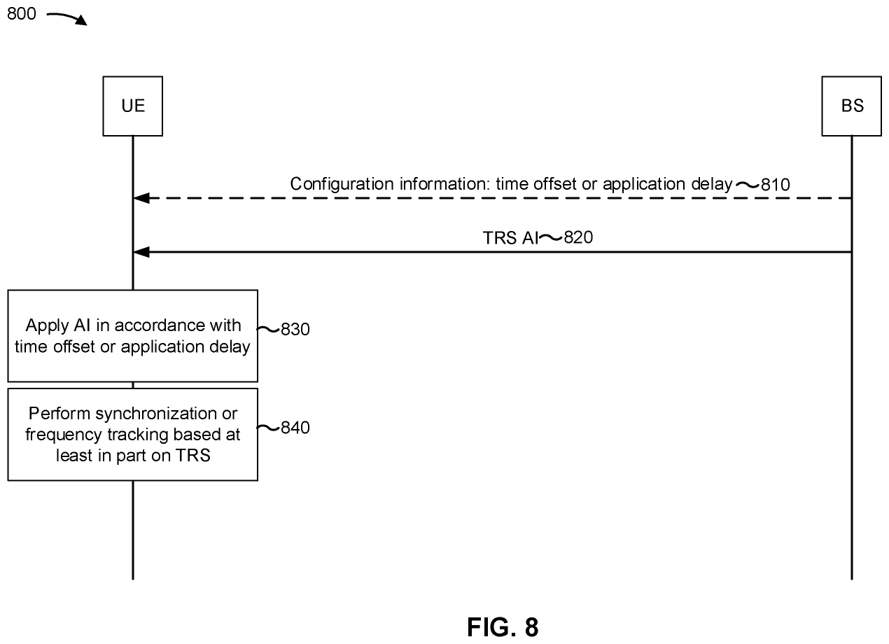

FIG. 8 is a diagram illustrating an example 800 of applying availability information after a time offset or application delay. As shown, example 800 includes a UE (e.g., UE 120) and a base station (e.g., base station 110). As mentioned above, in some deployments, the reference point for the start of a validity duration is the start of the first paging frame from the current default DRX cycle where the UE receives the availability indication. However, this is a non-causal condition, meaning that the availability information indicated by the availability indication may start taking effect before the UE receives the availability indication. This is problematic if an available TRS is switched to unavailable, because the UE may wrongly receive noise for tracking loop updating before the UE receives the PEI or paging PDCCH indicating that the TRS is not transmitted anymore, thereby degrading tracking by the UE. Techniques described with regard to example 800 provide an application delay or time offset that indicates a time for the availability information to take effect. The time occurs when or after the availability indication is received. Thus, the availability information is applied when or after the availability indication is received, thereby eliminating the situation where the UE is unaware that the status of a TRS resource set has changed until the availability indication is received.

At 810, the UE may optionally receive, and the base station may optionally transmit, configuration information. For example, the configuration information may be transmitted via RRC signaling, a SIB, or the like. The configuration information may indicate a time offset or an application delay. A time offset may indicate a length of time, and availability indication associated with the time offset may be applied at a time defined by the length of time after a reference point (for the start of the validity duration) associated with the availability indication. An application delay may indicate a number of DRX cycles (e.g., default DRX cycles) represented by X availability indication associated with the application delay may be applied at a time in the Xth DRX cycle after a DRX cycle in which the availability indication is received. In some aspects, the application delay or the time offset may be predefined, such as in a wireless communication specification. One example value for the application delay or the time offset is 1, though other values may be used.

At 820, the UE may receive, and the base station may transmit, an availability indication. For example, the availability indication may be included in or associated with a PEI or a paging PDCCH. The transmission of the availability indication is described in more detail elsewhere herein.

At 830, the UE may apply availability information indicated by the availability indication in accordance with the time offset or the application delay. For example, the UE may apply the availability indication starting at a time after the availability indication is received. In some aspects, the time is based at least in part on the time offset. For example, the time may be defined as “reference point+time offset.” In such examples, the time offset may have a time unit equal to a DRX cycle or a paging cycle for idle or inactive mode. In some aspects, the time is based at least in part on the application delay. For example, the time may be in the Xth DRX cycle after the current DRX cycle in which the UE receives the availability indication. In some aspects, the UE may monitor for a TRS in accordance with the availability indication. In some aspects, the UE may cease monitoring for a TRS in accordance with the availability indication. In some aspects, as shown by reference number 840, the UE may perform synchronization or frequency tracking (e.g., time synchronization, time re-synchronization, or frequency loop tracking) based at least in part on monitoring for the TRS. In this way, the availability information indicated by the availability indication is applied only after the availability indication is received, which reduces ambiguity for TRS signaling and which improves accuracy of tracking.

As indicated above, FIG. 8 is provided as an example. Other examples may differ from what is described with regard to FIG. 8.

FIG. 9 is a flowchart of an example method 900 of wireless communication. The method 900 may be performed by, for example, a user equipment (UE) (e.g., UE 120).

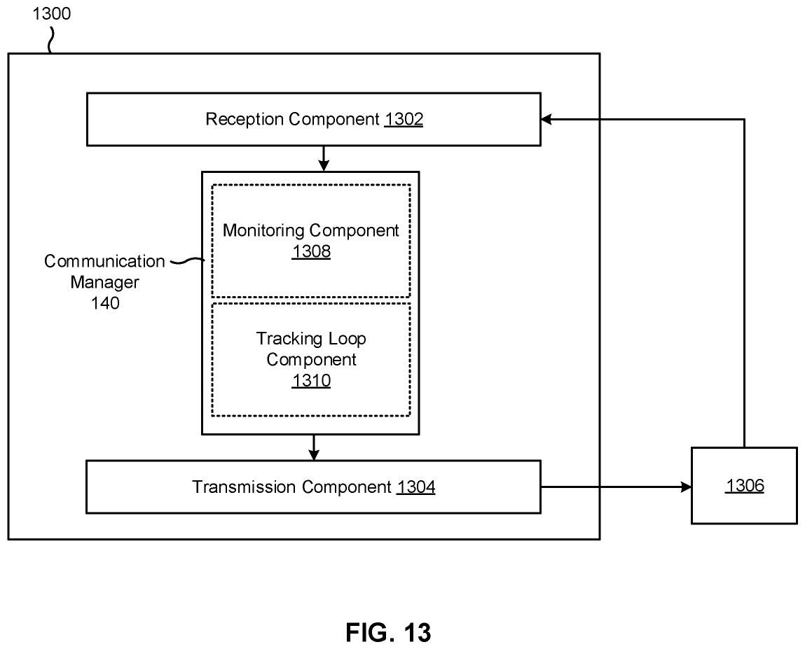

At 910, the UE may receive an availability indication associated with a TRS. For example, the UE (e.g., using communication manager 140 and/or reception component 1302, depicted in FIG. 13) may receive an availability indication associated with a TRS, as described above in connection with, for example, FIG. 5 and at 510.

In some aspects, the availability indication indicates that a particular group of TRS resource sets are available, and the validity duration is associated with the particular group of TRS resource sets. In some aspects, the particular group of TRS resource sets is a first group of TRS resource sets, the TRS is a first TRS, and the validity duration is a first validity duration, wherein the availability indication indicates that a second group of TRS resource sets are available, and wherein the method further comprises monitoring for a second TRS based at least in part on a second validity duration associated with the second group of TRS resource sets.

At 920, the UE may monitor for the TRS based at least in part on the availability indication and a validity duration. For example, the UE (e.g., using communication manager 140 and/or monitoring component 1308, depicted in FIG. 13) may monitor for the TRS based at least in part on the availability indication and a validity duration. In some aspects, the validity duration is based at least in part the availability indication indicating that at least one configured TRS resource set is available, as described in connection with FIG. 5. In some aspects, the validity duration is based at least in part on an indicator in the availability indication, as described in FIG. 6. In some aspects, the validity duration is based at least in part on a time at which the availability indication is received, as also described above in connection with, for example, FIG. 6. In some aspects, the validity duration is associated with all configured TRS resources associated with the availability indication.

In some aspects, the indicator identifies whether the availability indication is a first availability indication transmitted in the validity duration. In some aspects, the indicator includes a bit of a bitmap of the availability indication. In some aspects, the indicator identifies whether the availability indication is the first availability indication transmitted in the validity duration by indicating whether a group of TRS resource sets is available.

In some aspects, monitoring for the TRS based at least in part on the availability indication and the validity duration further comprises monitoring for the TRS for the validity duration based at least in part on the time being at least a threshold length of time after a prior availability indication. In some aspects, the threshold length of time is based at least in part on at least one of an integer multiple of a length of the validity duration, or a configurable offset.

At 930, the UE may perform synchronization or frequency tracking based at least in part on the TRS. For example, the UE (e.g., using communication manager 140 and/or tracking loop component 1310, depicted in FIG. 13) may perform synchronization (e.g., time synchronization or re-synchronization) or frequency tracking (e.g., frequency loop tracking) based at least in part on the TRS, as described above in connection with, for example, FIG. 5 and at 530, and FIG. 6 and at 640 and 660.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a flowchart of an example method 1000 of wireless communication. The method 1000 may be performed by, for example, a UE (e.g., UE 120).

At 1010, the UE may receive a first availability indication indicating first availability information associated with a tracking reference signal (TRS). For example, the UE (e.g., using communication manager 140 and/or reception component 1302, depicted in FIG. 13) may receive a first availability indication indicating first availability information associated with a tracking reference signal (TRS), as described above in connection with, for example, FIG. 6 and at 610.

At 1020, the UE may monitor for the TRS in accordance with the first availability information. For example, the UE (e.g., using communication manager 140 and/or monitoring component 1308, depicted in FIG. 13) may monitor for the TRS in accordance with the first availability information, as described above in connection with, for example, FIG. 6 and at 640. In some aspects, alone or in combination with one or more of the first and second aspects, monitoring for the TRS in accordance with the first availability information is based at least in part on a validity duration that is maintained by a network.

At 1030, the UE may receive, while monitoring for the TRS in accordance with the first availability information, a second availability indication indicating second availability information associated with the TRS. For example, the UE (e.g., using communication manager 140 and/or reception component 1302, depicted in FIG. 13) may receive, while monitoring for the TRS in accordance with the first availability information, a second availability indication indicating second availability information associated with the TRS, as described above in connection with, for example, FIG. 6 and at 650.

At 1040, the UE may monitor for the TRS, or cease monitoring for the TRS, in accordance with the second availability information. For example, the UE (e.g., using communication manager 140 and/or monitoring component 1308, depicted in FIG. 13) may monitor for the TRS, or cease monitoring for the TRS, in accordance with the second availability information, as described above in connection with, for example, FIG. 6 and at 660. As used herein, monitoring for a TRS may include monitoring one or more TRS resource sets indicated as available by an availability indication.

In some aspects, monitoring for the TRS, or ceasing monitoring for the TRS, in accordance with the second availability information further comprises monitoring for the TRS in accordance with the second availability indication based at least in part on the second availability information being received within a validity duration of the first availability indication.

In some aspects, monitoring for the TRS, or ceasing monitoring for the TRS, in accordance with the second availability information further comprises monitoring for the TRS during a validity duration associated with the second availability indication, and ceasing monitoring for the TRS after the validity duration has elapsed.

At 1050, the UE may optionally perform synchronization or frequency tracking based at least in part on the TRS. For example, the UE (e.g., using communication manager 140 or tracking loop component 1310, depicted in FIG. 13) may perform time synchronization, time re-synchronization, or frequency loop tracking based at least in part on the TRS.

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

FIG. 11 is a flowchart of an example method 1100 of wireless communication. The method 1100 may be performed by, for example, an UE (e.g., UE 120).

At 1110, the UE may receive an availability indication associated with a tracking reference signal (TRS), wherein the availability indication is received in a paging early indication (PEI) physical downlink control channel (PDCCH) or a paging PDCCH that indicates that no UE is paged. For example, the UE (e.g., using communication manager 140 and/or reception component 1302, depicted in FIG. 13) may receive an availability indication associated with a tracking reference signal (TRS), wherein the availability indication is received in a paging early indication (PEI) physical downlink control channel (PDCCH) or a paging PDCCH that indicates that no UE is paged, as described above in connection with, for example, FIG. 7 and at 710. In some aspects, a short message indicator field of the paging PDCCH indicates that no UE is paged.

In some aspects, the availability indication is received within a validity duration of a prior availability indication. In some aspects, alone or in combination with one or more of the first and second aspects, a prior availability indication indicates that one or more TRS resource sets are available, and wherein the availability indication indicates that the one or more TRS resource sets are no longer available.

At 1120, the UE may monitor for the TRS, or cease monitoring for the TRS, in accordance with the availability indication. For example, the UE (e.g., using communication manager 140 and/or monitoring component 1308, depicted in FIG. 13) may monitor for the TRS, or cease monitoring for the TRS, in accordance with the availability indication, as described above in connection with, for example, FIG. 7 and at 720.

Although FIG. 11 shows example blocks of method 1100, in some aspects, method 1100 may include additional blocks, fewer blocks, different blocks, or differently arranged blocks than those depicted in FIG. 11. Additionally, or alternatively, two or more of the blocks of method 1100 may be performed in parallel.

FIG. 12 is a flowchart of an example method 1200 of wireless communication. The method 1200 may be performed by, for example, an UE (e.g., UE 120).

At 1210, the UE may receive an availability indication associated with a tracking reference signal (TRS). For example, the UE (e.g., using communication manager 140 and/or reception component 1302, depicted in FIG. 13) may receive an availability indication associated with a tracking reference signal (TRS), as described above in connection with, for example, FIG. 8 and at 820.

At 1220, the UE may monitor one or more TRS resource sets in accordance with the availability indication, wherein the TRS starts at a time after the availability indication is received in accordance with a time offset or an application delay. For example, the UE (e.g., using communication manager 140 and/or monitoring component 1308, depicted in FIG. 13) may monitor one or more TRS resource sets in accordance with the availability indication, wherein the TRS starts at a time after the availability indication is received in accordance with a time offset or an application delay, as described above in connection with, for example, FIG. 8 and at 830. In some aspects, the time offset is relative to a first paging frame of a discontinuous reception cycle in which the UE receives the availability indication. In some aspects, alone or in combination with the first aspect, method 1200 includes receiving configuration information indicating the time offset. In some aspects, alone or in combination with one or more of the first and second aspects, the application delay indicates a discontinuous reception cycle, after a discontinuous reception cycle in which the availability indication is received, in which the TRS starts. In some aspects, alone or in combination with one or more of the first through third aspects, method 1200 includes receiving configuration information indicating the application delay.

At 1230, the UE may perform synchronization or frequency tracking based at least in part on the TRS. For example, the UE (e.g., using communication manager 140 and/or tracking loop component 1310, depicted in FIG. 13) may perform time synchronization, time re-synchronization, or frequency loop tracking based at least in part on the TRS based at least in part on the TRS, as described above in connection with, for example, FIG. 8 and at 840.

Although FIG. 12 shows example blocks of method 1200, in some aspects, method 1200 may include additional blocks, fewer blocks, different blocks, or differently arranged blocks than those depicted in FIG. 12. Additionally, or alternatively, two or more of the blocks of method 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a monitoring component 1308 or a tracking loop component 1310, among other examples.

In some aspects, the apparatus 1300 may be configured to perform one or more operations described herein in connection with FIGS. 5-8. Additionally, or alternatively, the apparatus 1300 may be configured to perform one or more processes described herein, such as the method 900 of FIG. 9, the method 1000 of FIG. 10, the method 1100 of FIG. 11, the method 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

In some aspects, the reception component 1302 may receive an availability indication associated with a tracking reference signal (TRS). The monitoring component 1308 may monitor for the TRS based at least in part on the availability indication and a validity duration, wherein the validity duration is based at least in part on at least one of the availability indication indicating that at least one configured TRS resource set is available, an indicator in the availability indication, or a time at which the availability indication is received. The tracking loop component 1310 may perform synchronization or frequency tracking based at least in part on the TRS.

In some aspects, the reception component 1302 may receive a first availability indication indicating first availability information associated with a tracking reference signal (TRS). The monitoring component 1308 may monitor for the TRS in accordance with the first availability information. The reception component 1302 may receive, while monitoring for the TRS in accordance with the first availability information, a second availability indication indicating second availability information associated with the TRS. The monitoring component 1308 may monitor for the TRS, or ceasing monitoring for the TRS, in accordance with the second availability information. The tracking loop component 1310 may perform synchronization or frequency tracking based at least in part on the TRS.

In some aspects, the reception component 1302 may receive an availability indication associated with a tracking reference signal (TRS), wherein the availability indication is received in a paging early indication (PEI) physical downlink control channel (PDCCH) or a paging PDCCH that indicates that no UE is paged. The monitoring component 1308 may monitor for the TRS, or ceasing monitoring for the TRS, in accordance with the availability indication. The monitoring component 1308 may cease monitoring for the TRS based at least in part on the availability indication.

The reception component 1302 may receive an availability indication associated with a tracking reference signal (TRS). The monitoring component 1308 may monitor one or more TRS resource sets in accordance with the availability indication, wherein the TRS starts at a time after the availability indication is received in accordance with a time offset or an application delay. The tracking loop component 1310 may perform synchronization or frequency tracking based at least in part on the TRS. The reception component 1302 may receive configuration information indicating the time offset. The reception component 1302 may receive configuration information indicating the application delay.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

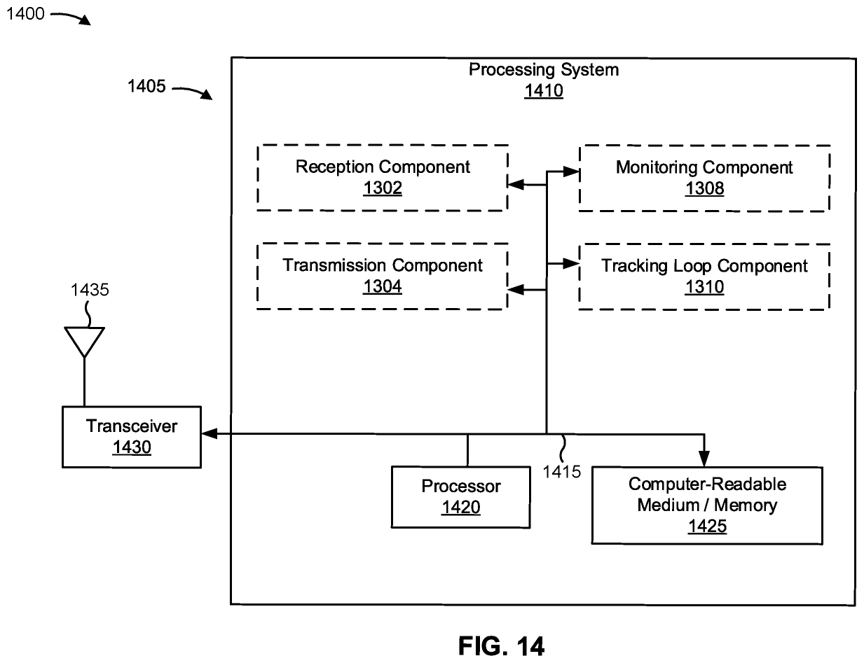

FIG. 14 is a diagram illustrating an example 1400 of a hardware implementation for an apparatus 1405 employing a processing system 1410. The apparatus 1405 may be a UE.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the UE 120 and may include the memory 282 and/or at least one of the TX MIMO processor 266, the RX processor 258, and/or the controller/processor 280. In some aspects, the apparatus 1405 for wireless communication includes means for receiving an availability indication associated with a TRS; means for monitoring for the TRS based at least in part on the availability indication and a validity duration, wherein the validity duration is based at least in part on at least one of: the availability indication indicating that at least one configured TRS resource set is available, an indicator in the availability indication, or a time at which the availability indication is received; means for performing synchronization or frequency tracking based at least in part on the TRS; means for receiving a first availability indication indicating first availability information associated with a TRS; means for monitoring for the TRS in accordance with the first availability information; means for receiving, while monitoring for the TRS in accordance with the first availability information, a second availability indication indicating second availability information associated with the TRS; means for monitoring for the TRS, or ceasing monitoring for the TRS, in accordance with the second availability information; means for receiving an availability indication associated with a TRS, wherein the availability indication is received in a PEI PDCCH or a paging PDCCH that indicates that no UE is paged; means for monitoring for the TRS, or ceasing monitoring for the TRS, in accordance with the availability indication; means for receiving an availability indication associated with a TRS; means for monitoring one or more TRS resource sets in accordance with the availability indication, wherein the TRS starts at a time after the availability indication is received in accordance with a time offset or an application delay; and/or means for performing synchronization or frequency tracking based at least in part on the TRS. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 14 is provided as an example. Other examples may differ from what is described in connection with FIG. 14.

The following provides an overview of some Aspects of the present disclosure:

Aspect 1: A method of wireless communication performed by a user equipment (UE), comprising: receiving an availability indication associated with a tracking reference signal (TRS); monitoring for the TRS based at least in part on the availability indication and a validity duration, wherein the validity duration is based at least in part on at least one of: the availability indication indicating that at least one configured TRS resource set is available, an indicator in the availability indication, or a time at which the availability indication is received; and performing synchronization or frequency tracking based at least in part on the TRS.

Aspect 2: The method of Aspect 1, wherein the availability indication indicates that a particular group of TRS resource sets are available, and wherein the validity duration is associated with the particular group of TRS resource sets.

Aspect 3: The method of Aspect 2, wherein the particular group of TRS resource sets is a first group of TRS resource sets, the TRS is a first TRS, and the validity duration is a first validity duration, wherein the availability indication indicates that a second group of TRS resource sets are available, and wherein the method further comprises: monitoring for a second TRS based at least in part on a second validity duration associated with the second group of TRS resource sets.

Aspect 4: The method of any of Aspects 1-3, wherein the validity duration is associated with all configured TRS resources associated with the availability indication.

Aspect 5: The method of any of Aspects 1-4, wherein the indicator identifies whether the availability indication is a first availability indication transmitted in the validity duration.

Aspect 6: The method of Aspect 5, wherein the indicator includes a bit of a bitmap of the availability indication.

Aspect 7: The method of Aspect 5, wherein the indicator identifies whether the availability indication is the first availability indication transmitted in the validity duration by indicating whether a group of TRS resource sets is available.

Aspect 8: The method of any of Aspects 1-7, wherein monitoring for the TRS based at least in part on the availability indication and the validity duration further comprises: monitoring for the TRS for the validity duration based at least in part on the time being at least a threshold length of time after a prior availability indication.

Aspect 9: The method of Aspect 8, wherein the threshold length of time is based at least in part on at least one of: an integer multiple of a length of the validity duration, or a configurable offset.

Aspect 10: A method of wireless communication performed by a user equipment (UE), comprising: receiving a first availability indication indicating first availability information associated with a tracking reference signal (TRS); monitoring for the TRS in accordance with the first availability information; receiving, while monitoring for the TRS in accordance with the first availability information, a second availability indication indicating second availability information associated with the TRS; and monitoring for the TRS, or ceasing monitoring for the TRS, in accordance with the second availability information.

Aspect 11: The method of Aspect 10, wherein monitoring for the TRS, or ceasing monitoring for the TRS, in accordance with the second availability information further comprises: monitoring for the TRS in accordance with the second availability indication based at least in part on the second availability information being received within a validity duration of the first availability indication.

Aspect 12: The method of any of Aspects 10-11, wherein monitoring for the TRS, or ceasing monitoring for the TRS, in accordance with the second availability information further comprises: monitoring for the TRS during a validity duration associated with the second availability indication; and ceasing monitoring for the TRS after the validity duration has elapsed.

Aspect 13: The method of any of Aspects 10-12, wherein monitoring for the TRS in accordance with the first availability information is based at least in part on a validity duration that is maintained by a network.

Aspect 14: The method of any of Aspects 10-13, further comprising: performing synchronization or frequency tracking based at least in part on the TRS.

Aspect 15: A method of wireless communication performed by a user equipment (UE), comprising: receiving an availability indication associated with a tracking reference signal (TRS), wherein the availability indication is received in a paging early indication (PEI) physical downlink control channel (PDCCH) or a paging PDCCH that indicates that no UE is paged; and monitoring for the TRS, or ceasing monitoring for the TRS, in accordance with the availability indication.

Aspect 16: The method of Aspect 15, wherein a short message indicator field of the paging PDCCH indicates that no UE is paged.

Aspect 17: The method of any of Aspects 15-16, wherein the availability indication is received within a validity duration of a prior availability indication.

Aspect 18: The method of any of Aspects 15-17, wherein a prior availability indication indicates that one or more TRS resource sets are available, and wherein the availability indication indicates that the one or more TRS resource sets are no longer available.

Aspect 19: The method of any of Aspects 15-18, further comprising ceasing monitoring for the TRS based at least in part on the availability indication.

Aspect 20: A method of wireless communication performed by a user equipment (UE), comprising: receiving an availability indication associated with a tracking reference signal (TRS); monitoring one or more TRS resource sets in accordance with the availability indication, wherein the TRS starts at a time after the availability indication is received in accordance with a time offset or an application delay; and performing synchronization or frequency tracking based at least in part on the TRS.

Aspect 21: The method of Aspect 20, wherein the time offset is relative to a first paging frame of a discontinuous reception cycle in which the UE receives the availability indication.

Aspect 22: The method of Aspect 21, further comprising receiving configuration information indicating the time offset.

Aspect 23: The method of any of Aspects 20-22, wherein the application delay indicates a discontinuous reception cycle, after a discontinuous reception cycle in which the availability indication is received, in which the TRS starts.

Aspect 24: The method of Aspect 23, further comprising receiving configuration information indicating the application delay.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an availability indication associated with a tracking reference signal (TRS);
monitor for the TRS based at least in part on the availability indication and a validity duration, wherein the validity duration is based at least in part on at least one of:
the availability indication indicating that at least one configured TRS resource set is available,
an indicator in the availability indication, or
a time at which the availability indication is received; and
perform synchronization or frequency tracking based at least in part on the TRS.

2. The UE of claim 1, wherein the availability indication indicates that a particular group of TRS resource sets are available, and wherein the validity duration is associated with the particular group of TRS resource sets.

3. The UE of claim 2, wherein the particular group of TRS resource sets is a first group of TRS resource sets, the TRS is a first TRS, and the validity duration is a first validity duration, wherein the availability indication indicates that a second group of TRS resource sets are available, and wherein the method further comprises:
monitor for a second TRS based at least in part on a second validity duration associated with the second group of TRS resource sets.

4. The UE of claim 1, wherein the validity duration is associated with all configured TRS resources associated with the availability indication.

5. The UE of claim 1, wherein the indicator identifies whether the availability indication is a first availability indication transmitted in the validity duration.

6. The UE of claim 5, wherein the indicator includes a bit of a bitmap of the availability indication.

7. The UE of claim 5, wherein the indicator identifies whether the availability indication is the first availability indication transmitted in the validity duration by indicating whether a group of TRS resource sets is available.

8. The UE of claim 1, wherein the one or more processors, to monitor for the TRS based at least in part on the availability indication and the validity duration, are configured to:
monitor for the TRS for the validity duration based at least in part on the time being at least a threshold length of time after a prior availability indication.

9. The UE of claim 8, wherein the threshold length of time is based at least in part on at least one of:
an integer multiple of a length of the validity duration, or
a configurable offset.

10. A user equipment (UE) for wireless communication, comprising:
a memory; and
one or more processors, coupled to the memory, configured to:
receive a first availability indication indicating first availability information associated with a tracking reference signal (TRS);
monitor for the TRS in accordance with the first availability information;
receive, while monitoring for the TRS in accordance with the first availability information, a second availability indication indicating second availability information associated with the TRS; and
monitor for the TRS, or ceasing monitoring for the TRS, in accordance with the second availability information.

11. The UE of claim 10, wherein the one or more processors, to monitor for the TRS, or ceasing monitoring for the TRS, in accordance with the second availability information, are configured to:
monitor for the TRS in accordance with the second availability indication based at least in part on the second availability information being received within a validity duration of the first availability indication.

12. The UE of claim 10, wherein the one or more processors, to monitor for the TRS, or ceasing monitoring for the TRS, in accordance with the second availability information, are configured to:
monitor for the TRS during a validity duration associated with the second availability indication; and
cease monitoring for the TRS after the validity duration has elapsed.

13. The UE of claim 10, wherein monitoring for the TRS in accordance with the first availability information is based at least in part on a validity duration that is maintained by a network.

14. The UE of claim 10, wherein the one or more processors are further configured to:
perform synchronization or frequency tracking based at least in part on the TRS.

15. A user equipment (UE) for wireless communication, comprising:
a memory; and
one or more processors, coupled to the memory, configured to:
receive an availability indication associated with a tracking reference signal (TRS), wherein the availability indication is received in a paging early indication (PEI) physical downlink control channel (PDCCH) or a paging PDCCH that indicates that no UE is paged; and
monitor for the TRS, or ceasing monitoring for the TRS, in accordance with the availability indication.

16. The UE of claim 15, wherein a short message indicator field of the paging PDCCH indicates that no UE is paged.

17. The UE of claim 15, wherein the availability indication is received within a validity duration of a prior availability indication.

18. The UE of claim 15, wherein a prior availability indication indicates that one or more TRS resource sets are available, and wherein the availability indication indicates that the one or more TRS resource sets are no longer available.

19. The UE of claim 15, wherein the one or more processors are further configured to cease monitoring for the TRS based at least in part on the availability indication.

20. A user equipment (UE) for wireless communication, comprising:
a memory; and
one or more processors, coupled to the memory, configured to:
receive an availability indication associated with a tracking reference signal (TRS);
monitor one or more TRS resource sets in accordance with the availability indication, wherein the TRS starts at a time after the availability indication is received in accordance with a time offset or an application delay; and
perform synchronization or frequency tracking based at least in part on the TRS.

21. The UE of claim 20, wherein the time offset is relative to a first paging frame of a discontinuous reception cycle in which the UE receives the availability indication.

22. The UE of claim 21, wherein the one or more processors are further configured to receive configuration information indicating the time offset.

23. The UE of claim 20, wherein the application delay indicates a discontinuous reception cycle, after a discontinuous reception cycle in which the availability indication is received, in which the TRS starts.

24. The UE of claim 23, wherein the one or more processors are further configured to receive configuration information indicating the application delay.
